(19) United States
(12) Patent Application Publication
(10) Pub. No.: US 2011/0025495 A1
(43) Pub. Date: Feb. 3, 2011

(54) TELEMATICS SYSTEM WITH LOCAL NETWORK

(75) Inventor: Bradley K. Allen, Redmond, WA (US)

Correspondence Address: BROOKS KUSHMAN P.C., 1000 TOWN CENTER, TWENTY-SECOND FLOOR, SOUTHFIELD, MI, 48075, US

(73) Assignee: Genie Industries, Inc., Redmond, WA (US)

(21) Appl. No.: 12/512,378

(22) Filed: Jul. 30, 2009

(51) Int. Cl. G08B 1/08

(52) U.S. Cl. 340/539.13

(57) ABSTRACT

A telematics system includes a central system, a telematics server unit, and a telematics local unit. The central system receives and processes information relating to a plurality of pieces of equipment located remotely from the central system, and provides services relating to the information to an end user. The telematics server unit includes a telecommunications device for wirelessly communicating with the central system. The telematics local unit installs at a piece of equipment and includes an input for receiving a condition of the piece of equipment. The telematics local unit further includes a local communications device for wirelessly communicating with the telematics server unit. The telematics server unit provides and facilitates communication between the telematics local unit and the central system.

### BACKGROUND OF THE INVENTION

1. Field of the Invention

The invention relates to telematics systems. The invention further relates to telematics units that are mounted to pieces of construction equipment to gather data (for example, GPS location, run-time hours, engine fault codes, etc.) from equipment, and to relay information (for example, shutdown codes, software updates, etc.) to equipment through cell phone or satellite phone services.

2. Background Art

The use of telematics systems has become widespread. In general, telematics is the convergence of telecommunications and information processing, and involves sending, receiving, and storing information via telecommunication devices.

In the construction industry, the ability to instrument machines and wirelessly transmit the resulting data may provide many advantages. A piece of construction equipment is provided with a telematics unit that includes GPS ability as well as the ability to gather other data (run-time hours, engine fault codes, etc.). The telematics unit also includes a cell phone (or satellite phone) for communicating information to a central system or remote data server. The cell phone may also receive information, or commands, and relay them to the equipment.

The remote data server receives and processes information from a number of pieces of equipment, and provides various services to an end user. For example, the data server may provide reports to the end user relating to equipment use and maintenance. Further, the data server may provide alarms, fault reporting, or other equipment management related information to the end user.

Current telematics systems require each piece of equipment to have a cell phone to communicate with the central system. Cell service becomes a significant cost in large fleets.

Background information may be found in U.S. Pub. Nos. 2004/0077347, 2005/0156735, 2006/0017565, and 2007/0252696. Further background information may be found in U.S. Pat. Nos. 5,331,318, 7,151,466, 7,343,264, 7,323,973, and 7,457,693.

### SUMMARY OF THE INVENTION

It is an object of the invention to provide an improved telematics system.

Many, if not most, pieces of construction equipment are on job sites with multiple pieces of equipment on the same site. In one aspect of the invention, an ability to communicate locally could limit the number of required cell services since, theoretically, only a single cell service is required per site. In preferred implementations, the system automatically handles any units being shipped in and out of a job site. It is appreciated that embodiments of the invention are not limited to construction equipment.

In one embodiment of the invention, a telematics system comprises a central system, a telematics server unit, and a telematics local unit. The central system receives and processes information relating to a plurality of pieces of equipment located remotely from the central system. Further, the central system provides services relating to the information to an end user. The telematics server unit includes a telecommunications device for wirelessly communicating with the central system. The telematics local unit is installed at a piece of equipment, and includes an input for receiving a condition of the piece of equipment. The telematics local unit further includes a local communications device for wirelessly communicating with the telematics server unit. The telematics server unit provides and facilitates communication between the telematics local unit and the central system.

In general, the telematics local unit may be configured to send a signal to the telematics server unit. The signal indicates the condition received at the input. In turn, the telematics server unit is configured to send information received from the telematics local unit to the central server.

It is appreciated that a telematics system may include one or more telematics server units, and one or more telematics local units, depending on the application. As well, embodiments of the invention may include various combinations of the additional comprehended features, as appropriate for the particular application.

In addition, it is also comprehended by the invention that the central system may be configured to send a signal to the telematics server unit. The telematics server unit, in turn, is configured to relay the signal, as appropriate, to the telematics local unit. The telematics local unit is configured to take action at the piece of equipment, as appropriate, based on the received signal.

It is appreciated that in one approach the telematics server unit may be installed at a second piece of equipment, and further include an input for receiving a condition of the second piece of equipment. One possibility is to make all pieces of equipment over a certain size have an installed telematics server unit. In turn, the telematics server unit may further include a global positioning system (GPS) device, and be configured to receive an input indicative of run-time hours and/or an input indicative of a diagnostic code.

It is appreciated that in another approach the telematics server unit may instead be a stand-alone unit. In this case, the telematics server unit may include a global positioning system (GPS) device.

In both approaches, the telematics local unit may be configured to receive an input indicative of run-time hours and/or an input indicative of a diagnostic code. It is appreciated that the telematics local unit may or may not include a global positioning system (GPS) device, as the nearest server unit may be used to approximate location of the local unit.

In a further aspect of the invention, in some embodiments, the telematics server unit further includes a local communications device that communicates with the local communications device on the telematics local unit. The local communications device on the telematics server unit and the local communications device on the telematics local unit may both be radio frequency devices. Of course, other types of communication are possible (for example, microwave, etc.).

Further, it is appreciated that the telecommunications device on the telematics server unit may take the form of a cellular communication device, or may take the form of a satellite communication device.

It is appreciated that various approaches may be taken to gather data at the telematics server unit from one or more telematics local units. In one implementation, the telematics server unit is configured with an owner code, and is configured to broadcast the owner code. The telematics local unit is configured with an owner code, and is configured such that when a received, broadcast owner code matches the owner code of the telematics local unit, the telematics local unit sends a signal to the telematics server unit. The sent signal indicates the condition received at the input.

The are many advantages associated with embodiments of the invention. For example, cell or satellite service costs may be reduced with embodiments of the invention because only a limited number of cell or satellite phones (telematics server units) are required. Theoretically, only a single server unit is required per site. The server unit could be integrated in a piece of large equipment or a stand-alone unit. In this way, a plurality of telematics local units may rely on the telematics server unit to send/receive information and communicate with the central system.

### BRIEF DESCRIPTION OF THE DRAWINGS

FIG. 1 illustrates a telematics system in an example embodiment of the invention, including a telematics server unit at a piece of large equipment and multiple telematics local units at corresponding pieces of small equipment;

FIG. 2 illustrates a stand-alone telematics server unit;

FIG. 3 illustrates a method of operation for a telematics server unit;

FIG. 4 illustrates a method of operation for a telematics local unit;

FIG. 5 illustrates an additional method of operation for a telematics server unit at a piece of large equipment;

FIG. 6 illustrates sending a signal from the central system, and relaying the signal to a piece of small equipment;

FIG. 7 illustrates sending a signal from the central system, and enabling, disabling, updating, or taking other action at a piece of large equipment; and

FIG. 8 illustrates receiving a relayed signal at a piece of small equipment, and enabling, disabling, updating, or taking other action at a piece of small equipment.

### DETAILED DESCRIPTION OF THE PREFERRED EMBODIMENTS

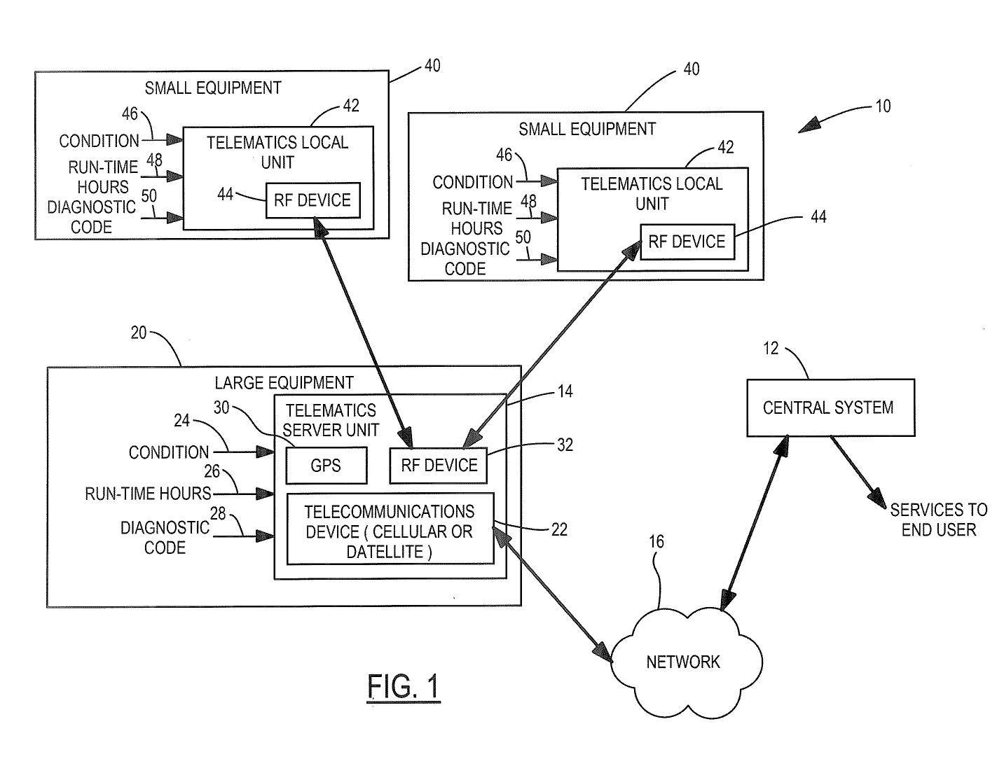

FIGS. 1-8 illustrate example embodiments of the invention. It is appreciated that a telematics system may include one or more telematics server units at pieces of large equipment and/or as stand-alone units, and may include one or more telematics local units. In addition, various combinations of the features may be employed as appropriate for any particular application of the invention.

In FIG. 1, a telematics system is generally indicated at 10. Telematics system 10 includes a central system 12 for receiving and processing information relating to a plurality of pieces of equipment located remotely from the central system 12, and for providing services relating to the information to an end user. Central system 12 communicates over any suitable network 16 with telematics server unit 14, which includes telecommunications device 22 for this purpose. For example, telecommunications device 22 may be a cellular communication device such as a cellular phone or may be a satellite communication device such as a satellite phone, with network 16 representing the appropriate network.

As shown, telematics server unit 14 includes various inputs for receiving conditions of the piece of large equipment 20 where telematics server unit 14 is installed. In more detail, telematics server unit 14 is shown receiving condition input 24 (which may represent any appropriate condition where telematics is desired). Other example inputs include run-time hours input 26 and diagnostic code input 28. Telematics server unit 14 also includes global positioning system (GPS) device 30.

In general, telematics server unit 14 monitors various conditions at large equipment 20, and uses telecommunications device 22 to wirelessly communicate over network 16 with central system 12.

Embodiments of the invention take advantage of the fact that many pieces of equipment, particularly in the construction industry, are on job sites with multiple pieces of equipment on the same site. An ability to communicate locally could limit the number of cell or satellite services required. As shown in FIG. 1, telematics server unit 14 further includes a local communication device in the form of a radio frequency communication device 32.

Pieces of small equipment 40 each include a telematics local unit 42, which includes a local communication device in the form of a radio frequency communication device 44. Of course, other forms of wireless communication could be used in the alternative such as, for example, microwave or laser. In more detail, each telematics local unit 42 is shown receiving a condition input 46 (which may represent any appropriate condition where telematics is desired). Other example inputs include run-time hours input 48 and diagnostic code input 50. Telematics local units 42 are shown without GPS devices and may rely on GPS device 30 in telematics server unit 14 to approximate position.

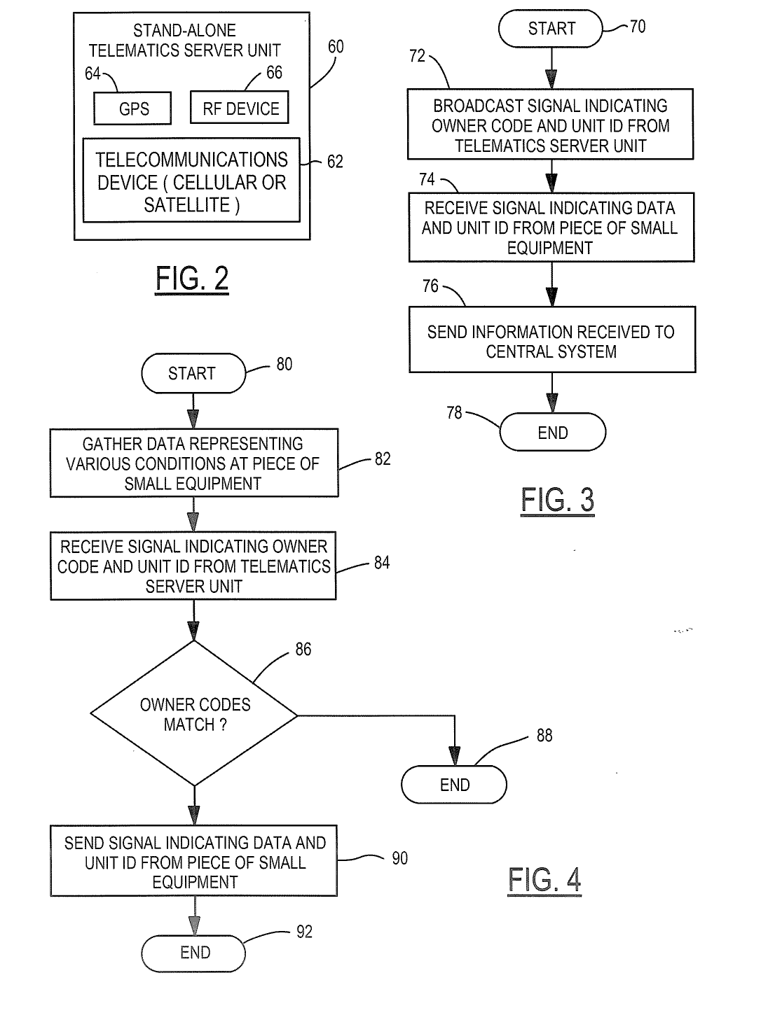

In accordance with the invention, telematics server unit 14 located at a piece of large equipment 20 and telematics local units 42 located at pieces of small equipment 40 communicate locally and wirelessly, and telematics server unit 14 includes the needed telecommunications device 22 such that server unit 14 collects data from the local units 42 and provides and facilitates communication of the collected data to the central system 12. Depending on the application, the telematics server unit may be mounted on or be integrally part of a larger piece of equipment as shown in FIG. 1, or, in the alternative, the server unit may be a stand-alone unit left at job sites as illustrated in FIG. 2. One possibility is to make all units over a certain size (for example, 80′ booms) include a telematics server unit.

FIG. 2 depicts stand-alone telematics server unit 60. Stand-alone telematics server unit 60 includes telecommunications device 62, global positioning system (GPS) device 64, and radio frequency device 66.

FIG. 3 illustrates a method of operation for a telematics server unit. The method begins at block 70. The telematics server unit is configured with an owner code and a unit identification code. At block 72, the telematics server unit broadcasts a signal indicating the owner code and unit identification. In response to the broadcasted signal, telematics local units send signals for the telematics server unit (described in more detail further below). At block 74, the telematics server unit receives these signals. A received signal indicates data and unit identification from a telematics local unit at a piece of small equipment. At block 76, the telematics server unit compiles data packets received and sends them to the central system. Flow ends at block 78.

FIG. 4 illustrates a method of operation for a telematics local unit. The method begins at block 80. At block 82, the telematics local unit gathers data representing various conditions (run-time hours, diagnostic codes, etc.) at a piece of small equipment. At block 84, the telematics local unit receives the signal from the telematics server unit indicating the owner code and the unit identification from the telematics server unit. Each telematics local unit also has its own owner code and unit identification. The telematics local unit checks to see if the received, broadcast owner code matches the owner code of the telematics local unit at block 86. If the telematics local unit owner code does not match the received owner code from the telematics server unit, then the telematics local unit is not associated with the telematics server unit (and possibly is not on the same job site) and flow proceeds to end at block 88.

When the owner codes do match, flow proceeds to block 90 and the telematics local unit sends a signal to the telematics server unit indicating one or more conditions of the equipment where the telematics local unit is installed. That is, when the received signal has the same owner code, the telematics local unit transmits its data packet and unit identification at block 90. Flow then ends at block 92.

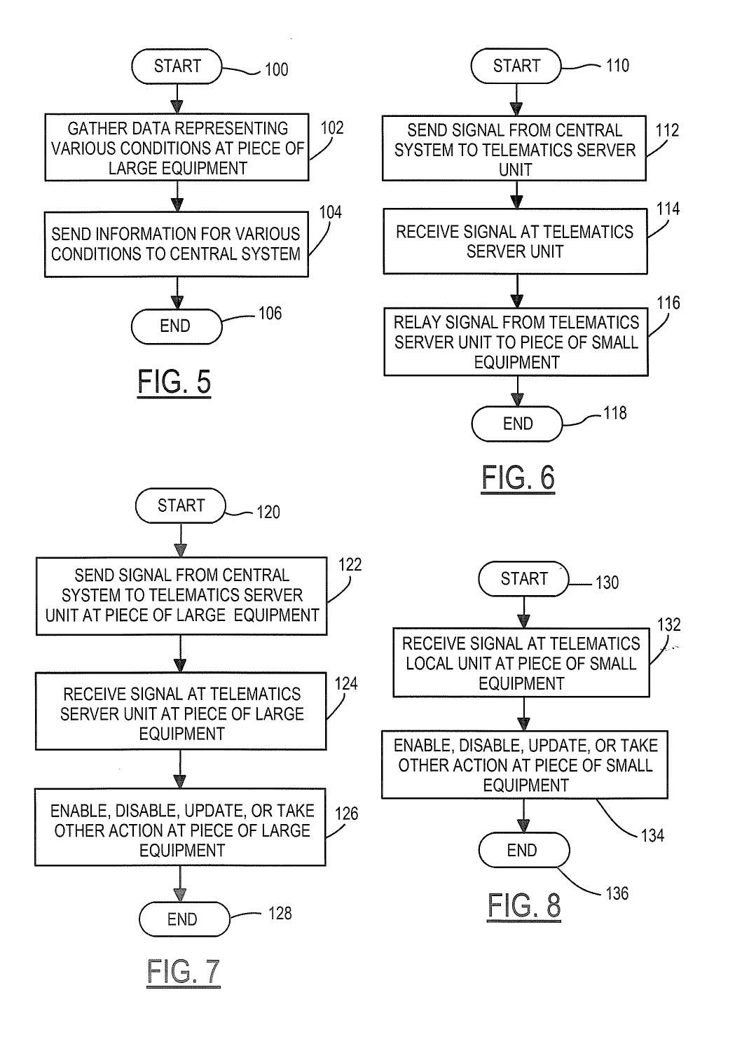

As noted above, the telematics server unit may be a stand-alone unit or may be installed on a piece of equipment (typically, on a larger piece of equipment to justify the expense). As shown in FIG. 5, when the telematics server unit is installed at a piece of equipment, in addition to collecting data packets from the smaller units (telematics local units), the telematics server unit also gathers and sends data to the central system for its own equipment. Flow begins at block 100. Block 102 depicts gathering data representing various conditions at the piece of large equipment where the telematics server unit is installed. At block 104, information is sent to the central system. Flow ends at block 106.

The central system 12 (FIG. 1) receives calls, separates data packets, eliminates duplicate data packets, and compiles the data in order to provide services to end users. There are many advantages associated with the telematics system 10 of FIG. 1 and with other telematics systems implemented in accordance with any one or more features of the invention. For example, many, if not most, units do not require cellular (or satellite) phone service. As long as there is at least one telematics server unit at a job site, all of the units in the local area may be tracked. Preferably, units may be dropped off at the site and picked up with no loss of service, so long as at least one telematics server unit remains on site or within the area within radio frequency range. In another alternative, a stand-alone telematics server unit could be installed on a site and connected to a land line at sites where there is no or unreliable cell service. Advantageously, embodiments of the invention may be implemented such that no configuration is required on delivering units, either local units or server units. A server unit may simply receive information from local units within range, and transmit data back to the central system. This could even mean that a server unit on one site might receive information from a local unit on another (but nearby) site, or even receive data from a local unit on a truck passing by.

In addition to the data gathering capabilities described above, embodiments of the invention may also provide the relaying of information from the central system 12 (FIG. 1) to the telematics units 14, 42. In FIG. 6, sending a signal from the central system is illustrated. Flow begins at block 110. At block 112, a signal is sent from the central system to the telematics server unit. At block 114, the signal is received at the telematics server unit. As appropriate, at block 116, the signal is relayed to one or more telematics local units at the small pieces of equipment. Flow ends at block 118. The information sent from the central server may include, for example, shutdown codes, software updates, etc.

FIG. 7 illustrates enabling, disabling, updating, or taking other action at a piece of large equipment in response to a signal from the central server. FIG. 8 illustrates enabling, disabling, updating, or taking other action at a piece of small equipment in response to a signal from the central server.

In FIG. 7, flow begins at block 120. At block 122, a signal is sent from the central system to a telematics server unit at a piece of large equipment. At block 124, the signal is received at the telematics server unit at the piece of large equipment. At block 126, enabling, disabling, updating, or some other action is taken at the piece of large equipment, as appropriate. Flow ends at block 128. For example, with regard to an enabling signal, some applications of a telematics system may require that the piece of large equipment is required to receive an enabling signal to enable the equipment or some feature of the equipment. Similarly, with regard to a disabling signal, in some applications, a signal may be sent to disable equipment or some feature of the equipment. Further, software updates for the telematics unit or the equipment itself may be sent from the central system. As well, other types of signals are possible.

In FIG. 8, flow begins at block 130. At block 132, a signal is received at a telematics local unit at a piece of small equipment. At block 134, enabling, disabling, updating, or some other action is taken at the piece of small equipment, as appropriate. Flow ends at block 136.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A telematics system comprising:
a central system for receiving and processing information relating to a plurality of pieces of equipment located remotely from the central system, and for providing services relating to the information to an end user;
a telematics server unit including a telecommunications device for wirelessly communicating with the central system;
a telematics local unit for installation at a piece of equipment and including an input for receiving a condition of the piece of equipment, the telematics local unit further including a local communications device for wirelessly communicating with the telematics server unit; and
wherein the telematics server unit provides and facilitates communication between the telematics local unit and the central system.

2. The telematics system of claim 1 wherein the telematics server unit is for installation at a second piece of equipment and further includes an input for receiving a condition of the second piece of equipment.

3. The telematics system of claim 2 wherein the telematics server unit includes a global positioning system (GPS) device.

4. The telematics system of claim 2 wherein the telematics server unit is configured to receive an input indicative of run-time hours.

5. The telematics system of claim 2 wherein the telematics server unit is configured to receive an input indicative of a diagnostic code.

6. The telematics system of claim 1 wherein the telematics server unit is a stand-alone unit.

7. The telematics system of claim 6 wherein the telematics server unit includes a global positioning system (GPS) device.

8. The telematics system of claim 1 wherein the telematics server unit further includes a local communications device that communicates with the local communications device on the telematics local unit.

9. The telematics system of claim 8 wherein the local communications device on the telematics server unit and the local communications device on the telematics local unit are both radio frequency devices.

10. The telematics system of claim 1 wherein the telematics local unit is configured to receive an input indicative of run-time hours.

11. The telematics system of claim 1 wherein the telematics local unit is configured to receive an input indicative of a diagnostic code.

12. The telematics system of claim 1 wherein the telecommunications device on the telematics server unit is a cellular communication device.

13. The telematics system of claim 1 wherein the telecommunications device on the telematics server unit is a satellite communication device.

14. The telematics system of claim 1 wherein the telematics local unit is configured to send a signal to the telematics server unit, the signal indicating the condition received at the input; and
wherein the telematics server unit is configured to send information received from the telematics local unit to the central server.

15. The telematics system of claim 1 wherein the telematics server unit is configured with an owner code, and is configured to broadcast the owner code; and
wherein the telematics local unit is configured with an owner code, and is configured such that when a received, broadcast owner code matches the owner code of the telematics local unit, the telematics local unit sends a signal to the telematics server unit, the signal indicating the condition received at the input.

16. The telematics system of claim 1 wherein the central system is configured to send a signal to the telematics server unit;
wherein the telematics server unit is configured to relay the signal, as appropriate, to the telematics local unit; and
wherein the telematics local unit is configured to take action at the piece of equipment, as appropriate, based on the received signal.

17. A telematics system comprising:
a telematics server unit including a telecommunications device for wirelessly communicating with a central system;
a plurality of telematics local units, each telematics local unit being configured for installation at a corresponding piece of equipment and including an input for receiving a condition of the piece of equipment, each telematics local unit further including a local communications device for wirelessly communicating with the telematics server unit; and
wherein the telematics server unit provides and facilitates communication between the telematics local unit and the central system.

18. The telematics system of claim 17 wherein each telematics local unit is configured to send a signal to the telematics server unit, the signal indicating the condition received at the input; and
wherein the telematics server unit is configured to send information received from each telematics local unit to the central server.

19. The telematics system of claim 17 wherein the telematics server unit is configured with an owner code, and is configured to broadcast the owner code; and
wherein each telematics local unit is configured with an owner code, and is configured such that when a received, broadcast owner code matches the owner code of the telematics local unit, the telematics local unit sends a signal to the telematics server unit, the signal indicating the condition received at the input.

20. A telematics system comprising:
a telematics server unit including a telecommunications device for communicating with a central system;
a telematics local unit for installation at a piece of equipment and including an input for receiving a condition of the piece of equipment, the telematics local unit further including a local communications device for wirelessly communicating with the telematics server unit; and
wherein the telematics server unit provides and facilitates communication between the telematics local unit and the central system.
